(19) United States
(12) Patent Application Publication
(10) Pub. No.: US 2009/0294515 A1
(43) Pub. Date: Dec. 3, 2009

(54) Mounting integrated circuit components on substrates

(76) Inventors: Edward R. Prack, Phoenix, AZ (US); Amram Eitan, Scottsdale, AZ (US)

Correspondence Address: TROP, PRUNER & HU, P.C., 1616 S. VOSS RD., SUITE 750, HOUSTON, TX, 77057-2631, US

(21) Appl. No.: 12/156,151

(22) Filed: May 30, 2008

(51) Int. Cl. B23K 31/02

(52) U.S. Cl. 228/212; 228/101

(57) ABSTRACT

A poly(alkylene carbonate) tack agent may be used to secure an electrical component, such as an integrated circuit, to a substrate for soldering. The tack agent may disintegrate or vaporize at normal reflow temperatures so that no clean up is needed. In some embodiments, flexless soldering may be implemented. If flux is desired, the flux may be mixed with the tack agent in some embodiments. For example, the flux may be incorporated in microcapsules within the tack agent.

### BACKGROUND

This relates generally to mounting integrated circuit components, including integrated circuits, integral heat spreaders, and other components to substrates such as packages, printed circuit boards, and other surfaces.

Commonly, an integrated circuit chip is mounted to a substrate for packaging purposes. This may be done by using a tack agent to temporarily secure the integrated circuit to the substrate while solder bond or solder ball connections are made through the application of heat. Thus, the idea is to hold a component, such as an integrated circuit, in position while it is being soldered in place.

After the chip is soldered in position, the tack agent may remain as a contaminant, either on the component being secured or the substrate to which the component is secured.

### BRIEF DESCRIPTION OF THE DRAWINGS

FIG. 1 is a partial, enlarged cross-section of an initial stage in accordance with one embodiment of the present invention;

FIG. 2 is a partial, enlarged cross-section at a subsequent stage in accordance with one embodiment;

FIG. 3 is an enlarged, partial cross-section of still another stage;

FIG. 4 is an enlarged, partial cross-section of another embodiment; and

FIG. 5 is a flow chart for some embodiments of the present invention.

### DETAILED DESCRIPTION

Two integrated circuit components may be temporarily secured together, preparatory to soldering, using a tack agent. The tack agent may be effective to secure the components together while solder connections are made to more permanently secure the two components. For example, an integrated circuit may be secured to a substrate, such as a printed circuit board, a package, or any other surface. Likewise, an integral heat spreader may be secured to a package, an integrated circuit, or some other component. Upon exposure to the heat inherent in soldering, the tack agent is automatically removed.

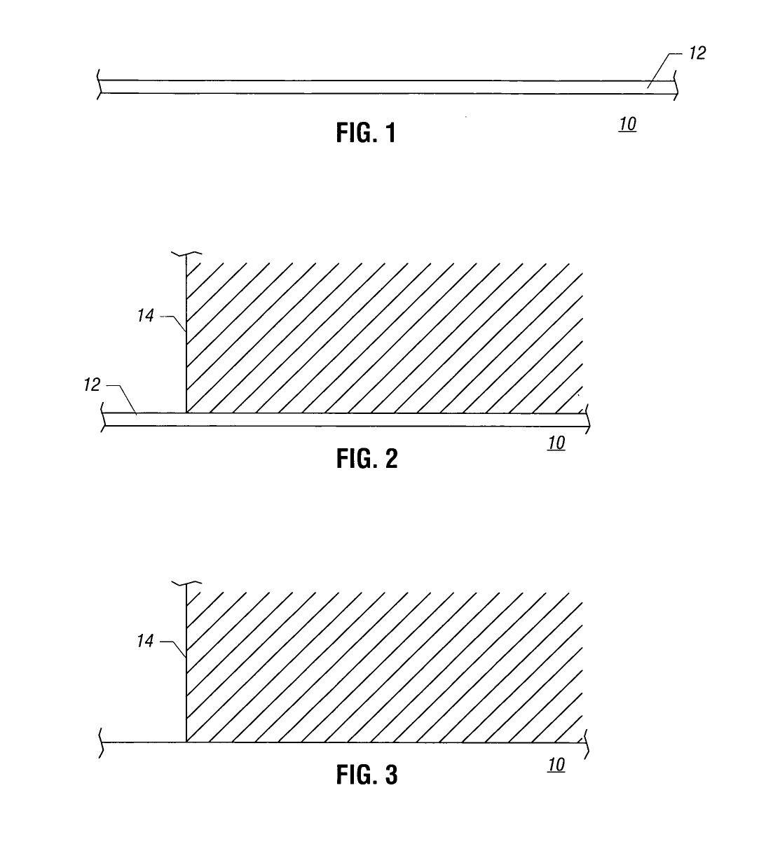

Referring to FIG. 1, a substrate 10 may receive a tack agent 12 in accordance with one embodiment of the present invention. The substrate 10 may be a circuit board, a package, or any other surface. In one embodiment, the tack agent 12 may be a material which vaporizes at reflow temperatures, but which is sufficiently tacky to secure an integrated circuit component to the substrate 10 prior to vaporization.

Thus, as shown in FIG. 2, an integrated circuit component 14, such as an integrated circuit die, may be secured to the substrate 10 temporarily by the tack agent 12. In one embodiment, the tack agent 12 may be a material including poly(alkylene carbonate) copolymer. One suitable material is QPAC® decomposable binder from Empower Materials, Inc., Newark, Del. 19711 Another suitable material is Number 2203, available from Promerus, L.L.C., Brecksville, Ohio 44141.

The tack agent 12 may be supplied as a spray or a print, as two examples. When the soldered electrical connections are made, for example, through solder balls, surface mounts, or wire bonds, an elevated temperature may be used which causes the tack agent 12 to vaporize. For example, in some embodiments, the tack agent 12 may vaporize at temperatures of 220° C. to 265° C. The decomposition temperature and decomposition rate can be tailored through the selection of alkylene units and functional end groups.

While the tack agent is applied to the substrate in FIG. 1, in other embodiments the tack agent is instead applied to the die. For example, the tack agent may be applied to solder balls on a die.

Thus, as a result of vaporization of the tack agent, the integrated circuit component 14 rests directly on the substrate 10, as shown in FIG. 3. The component 14 now may be secured to the substrate 10 by soldered electrical connections (not shown).

Because the tack agent 12 vaporizes at reflow temperatures, there is no need to clean the product. For example, the agent 12 may decompose into carbon dioxide and water. Nevertheless, adequate tack is provided to avoid misalignment problems during soldering. There is also no need for halide reducing agents in some embodiments.

Using a reflow operation, with tack agent, a reducing atmosphere reflow may be utilized. For example, in accordance with some embodiments of the present invention, a system may be utilized wherein a reducing atmosphere reflow furnace is utilized, such as a Geneva serial thermal processor (STP), available from SEMIgear, Inc., Wakefield, Mass. 01880. The Geneva STP can secure an integrated circuit to a substrate without the use of flux for soldering. The STP system eliminates the flux dispensing system before reflow and defluxing after soldering. The STP system may use a formic acid atmosphere that provides a flux function.

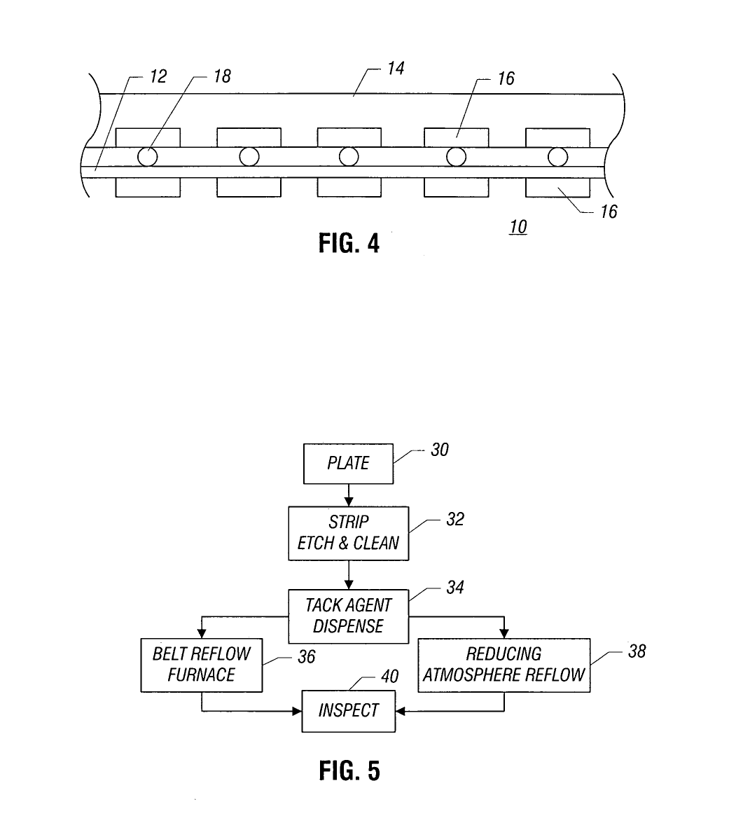

Referring to FIG. 4, which may be a different embodiment than the one shown in FIGS. 1-3, in a flip chip or surface mount application, the component 14 to be secured may include lands 16 that are eventually soldered or surface mounted to solder balls 18. The solder balls 18 are also bonded to pads 16 associated with the substrate 10. Thus, in one example, the substrate 10 may be an integrated circuit board and the component 14 may be an integrated circuit with soldered balls.

Preparatory to surface mounting, the component 14 may be secured to the substrate 10 by the tack agent 12. The tack agent may be initially applied to either of the substrate 10 or component 14. During surface mounting, due to applied heat, the tack agent 12 vaporizes, as described above. The securement may be by way of a tack agent 12, including formic acid mixed into the tack agent so that the formic acid acts as a flux or, alternatively, the furnace may include a reducing atmosphere, as is the case with the Geneva STP 300.

Referring to FIG. 5, after plating, as indicated in block 30, the substrate 10 may be stripped, etched, and cleaned, as indicated in block 32. The tack agent 12 is dispensed, as indicated in block 34 and as shown in FIG. 1. Then, the component, such as the component 14, may be positioned on the tack agent 12 and held thereon during soldering.

In one embodiment, a belt reflow furnace may be utilized, as indicated in block 36. Other reflow furnaces may also be utilized. In some embodiments, there is no need for a reducing atmosphere dispensing, the use of a reducing atmosphere washing machine, or tin shell formation. After completion, an inspection process may be implemented at block 40.

In the embodiments using flux, the tack agent 12 may be a carrier with a flux, such as a formic acid reducing agent, mixed in at low levels, fox example, one to two percent by weight, optimized for formulation stability and reflow joint performance. For example, the formic acid reducing agent may be microencapsulated in one embodiment. The microencapsulation may disintegrate or vaporize at belt reflow furnace temperatures, releasing the formic acid to act as a fluxing agent during soldering without affecting the operation of the tack agent prior to soldering. During reflow, the tack agent 12 microencapsulation decomposes, releasing the formic acid to reduce metal oxides during reflow, resulting in a robust solder joint. The resulting formats may be removed by the air flow in the reflow system.

Alternatively, after dispensing the tack agent, a reducing atmosphere reflow may be used, for example a Geneva STP 300 as indicated at block 38. In such case, no flux may be needed.

References throughout this specification to “one embodiment” or “an embodiment” mean that a particular feature, structure, or characteristic described in connection with the embodiment is included in at least one implementation encompassed within the present invention. Thus, appearances of the phrase “one embodiment” or “in an embodiment” are not necessarily referring to the same embodiment. Furthermore, the particular features, structures, or characteristics may be instituted in other suitable forms other than the particular embodiment illustrated and all such forms may be encompassed within the claims of the present application.

While the present invention has been described with respect to a limited number of embodiments, those skilled in the art will appreciate numerous modifications and variations therefrom. It is intended that the appended claims cover all such modifications and variations as fall within the true spirit and scope of this present invention.

What is claimed is:

1. A method comprising:
using a tack agent with microencapsulated flux to temporarily secure an electrical component to a substrate during soldering; and
heating the tack agent as a result of soldering so as to vaporize said tack agent and to release said flux.

2. The method of claim 1 including using a poly(alkylene carbonate) tack agent.

3. The method of claim 1 including using a tack agent that vaporizes at a temperature of about 220° C. to 265° C.

4. The method of claim 1 including applying heat to solder said component to said substrate, said heat being sufficient to vaporize said tack agent.

5. The method of claim 4 wherein applying heat includes implementing a reflow.

6-9. (canceled)

10. The method of claim 1 including attaching an integrated circuit die to a substrate using said tack agent.

11. The method of claim 1 including securing an integrated circuit including solder balls to a substrate using said tack agent.

12. The method of claim 1 including using a tack agent that vaporizes at a temperature above 220° C.

13. The method of claim 1 including securing a die to an integrated circuit package by using a tack agent to hold said die on said package while surface mounting said die to said package.

14. A method comprising:
soldering connections from an integrated circuit to a substrate by applying heat sufficient to vaporize a tack agent holding said integrated circuit to said substrate; and
microencapsulating a flux within said tack agent.

15. The method of claim 14 including using a tack agent having poly(alkylene carbonate).

16. The method of claim 15 wherein soldering includes applying heat in a reflow process.

17. The method of claim 14 including soldering with flux.

18. The method of claim 14 including soldering without flux.

19-20. (canceled)
